(19) United States
(12) Patent Application Publication
(10) Pub. No.: US 2025/0047099 A1
(43) Pub. Date: Feb. 6, 2025

(54) POWER MANAGEMENT METHOD AND DEVICE, ENERGY MANAGEMENT DEVICE, AND ENERGY SYSTEM

(71) Applicant: SHENZHEN HELLO TECH ENERGY CO., LTD, Shenzhen (CN)

(72) Inventors: Jian FANG, Shenzhen (CN); Shengxiang KONG, Shenzhen (CN)

(21) Appl. No.: 18/423,322

(22) Filed: Jan. 26, 2024

Related U.S. Application Data
(63) Continuation of application No. PCT/CN2023/126405, filed on Oct. 25, 2023.

(30) Foreign Application Priority Data
Aug. 2, 2023 (CN) 202310970743.0
Aug. 3, 2023 (CN) 202310979971.4

(51) Int. Cl. H02J 3/38; G06Q 50/06; H02J 13/00

(52) U.S. Cl. CPC H02J 3/38; G06Q 50/06; H02J 13/00002

(57) ABSTRACT

The present disclosure provides a power management method, a power management device (10), an energy management device (70), an energy system (100), and a storage medium (300). The power management method includes: obtaining first generated power of the first power generation device (30) and consumed power of the one or more loads (200); controlling, when the first generated power is greater than the consumed power, the energy storage device (50) to store power; and outputting, based on a determined electricity selling period, electric quantity of the energy storage device (50) to a power grid (400) during the electricity selling period.

### PRIORITY INFORMATION

This application is a continuation of International Application No. PCT/CN2023/126405 filed on Oct. 25, 2023, which claims a priority to Chinese Patent Application No. 202310970743.0 and No. 202310979971.4, filed with China National Intellectual Property Administration on Aug. 2, 2023 and Aug. 3, 2023 respectively, the entire contents of which are incorporated herein by reference.

### FIELD

The present disclosure relates to the field of energy management technologies, and more particularly, to a power management method, a power management device, an energy management device, an energy system, and a non-volatile computer-readable storage medium.

### BACKGROUND

With the development and evolution of new energy sources, many households no longer rely on a public power grid for power supply, but rather choose the new energy to supply power to household, such as photovoltaic power generation, wind power generation, and tidal power generation, etc. However, when the power supply method with new energy is used to supply power to households and after meeting needs of household appliances, excess power produced by the new energy method will be wasted or purchased by the public power grid at a lower price. When the new energy generation method is not able to meet the needs of household appliances, the power will need to be re-purchased from the public power grid at a higher price, thus increasing household power consumption cost.

### SUMMARY

Embodiments of the present disclosure provide a power management method, a power management device, an energy management device, an energy system, and a non-volatile computer-readable storage medium.

According to the embodiments of the present disclosure, the power management method is applied to the energy system. The energy system includes a first power generation device, a power distribution device, and an energy storage device. The power distribution device is connected to the first power generation device, the energy storage device and one or more loads. The first power generation device is configured to supply power to the power distribution device. The power management method includes: obtaining first generated power of the first power generation device and consumed power of the one or more loads; controlling, when the first generated power is greater than the consumed power, the energy storage device to store power; determining, based on a predetermined on-grid electricity price curve, an electricity selling period, the on-grid electricity price curve including a plurality of electricity price periods, the electricity selling period being an electricity price period having an electricity price ranking that satisfies a predetermined ranking among the plurality of electricity price periods, and the electricity price ranking being based on an electricity selling price; and outputting electric quantity of the energy storage device to a power grid during the electricity selling period, such that, residual electric quantity of the energy storage device after said outputting to the power grid is greater than first predetermined electric quantity.

According to the embodiments of the present disclosure, the power management device is applied to the energy system. The energy system includes a first power generation device, a power distribution device, and an energy storage device. The power distribution device is connected to the first power generation device, the energy storage device, and one or more loads. The first power generation device is configured to supply power to the power distribution device. The power management device includes a first obtaining module and a first control module. The first obtaining module is configured to obtain first generated power of the first power generation device and consumed power of the one or more loads. The first control module is configured to control, when the first generated power is greater than the consumed power, the energy storage device to store power. A first determining module is configured to determine, based on a predetermined on-grid electricity price curve, an electricity selling period. The on-grid electricity price curve includes a plurality of electricity price periods. The electricity selling period is an electricity price period having an electricity price ranking that satisfies a predetermined ranking among the plurality of electricity price periods, and the electricity price ranking is based on an electricity selling price. A transaction module is configured to output electric quantity of the energy storage device to a power grid during the electricity selling period, such that, residual electric quantity of the energy storage device after said outputting to the power grid is greater than first predetermined electric quantity.

According to the embodiments of the present disclosure, the energy management device includes a processor and a memory storing a computer program. The computer program, when executed by the processor, implements the steps of the power management method. The power management method includes: obtaining first generated power of the first power generation device and consumed power of the one or more loads; controlling, when the first generated power is greater than the consumed power, the energy storage device to store power; determining, based on a predetermined on-grid electricity price curve, an electricity selling period, the on-grid electricity price curve including a plurality of electricity price periods, the electricity selling period being an electricity price period having an electricity price ranking that satisfies a predetermined ranking among the plurality of electricity price periods, and the electricity price ranking being based on an electricity selling price; and outputting electric quantity of the energy storage device to a power grid during the electricity selling period, such that residual electric quantity of the energy storage device after said outputting to the power grid is greater than first predetermined electric quantity.

According to the embodiments of the present disclosure, the energy system includes a first power generation device, a power distribution device, an energy storage device, and the energy management device. The energy management device is connected to the first power generation device, the power distribution device, and the energy storage device, and the power distribution device is connected to the first power generation device, the energy storage device, and the one or more loads.

According to the embodiments of the present disclosure, the non-volatile computer-readable storage medium has a computer program. The computer program, when executed by a processor, causes the processor to implement the power management method. The power management method includes: obtaining first generated power of the first power generation device and consumed power of the one or more loads; controlling, when the first generated power is greater than the consumed power, the energy storage device to store power; determining, based on a predetermined on-grid electricity price curve, an electricity selling period, the on-grid electricity price curve including a plurality of electricity price periods, the electricity selling period being an electricity price period having an electricity price ranking that satisfies a predetermined ranking among the plurality of electricity price periods, and the electricity price ranking being based on an electricity selling price; and outputting electric quantity of the energy storage device to a power grid during the electricity selling period, such that residual electric quantity of the energy storage device after said outputting to the power grid is greater than first predetermined electric quantity.

According to the embodiments of the present disclosure, the power management method, the power management device, the energy management device, the energy system, and the non-volatile computer-readable storage medium are able to apply the power management method to the energy system. The energy system includes the first power generation device, the power distribution device, and the energy storage device. By connecting the power distribution device to the first power generation device, the first power generation device is able to supply power to the power distribution device. Then, by connecting the power distribution device to the energy storage device and the one or more loads, power generated by the first power generation device is transmitted to the energy storage device and the one or more loads, which enables the first generated power of the first power generation device and the consumed power of the one or more loads to be obtained, and in turn learns whether the power generated by the first power generation device can satisfy the one or more loads. When the first generated power of the first power generation device is greater than the consumed power of the one or more loads, i.e., when the power generated by the first power generation device satisfies the consumed power of the one or more loads, there is still excess power. In this case, the energy storage device can be controlled to store power (For example, by adjusting input power of the energy storage device), and the excess power generated by the first power generation device can be stored in the energy storage device. In addition, an electricity selling price of each of the plurality of electricity price periods is ranked based on the predetermined on-grid electricity price curve, and electric quantity of the energy storage device that is more than the first predetermined electric quantity is output to the public power grid during an electricity price period having an electricity price ranking that satisfies a predetermined ranking. Compared with the situation in which the excess power generated by the first power generation device can only be wasted or purchased by the public power grid at a low price in the energy system without energy storage device, the energy storage device ensures that the power generated by the first power generation device can be self-consumed as much as possible, and power from the public power grid is used as little as possible, which reduces household electricity cost.

Additional aspects and advantages of the embodiments of the present disclosure will be given at least in part in the following description, or become apparent at least in part from the following description, or can be learned from practicing of the embodiments of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a schematic flowchart of a power management method according to some embodiments of the present disclosure.

FIG. 2 is a schematic plane diagram of an energy system according to some embodiments of the present disclosure.

FIG. 3 is a schematic graph of a generated power curve and a consumed power curve according to some embodiments of the present disclosure.

FIG. 4 is a schematic graph of an on-grid electricity price curve and an electricity consumption price curve according to some embodiments of the present disclosure.

FIG. 5 is a schematic flowchart of a power management method according to some embodiments of the present disclosure.

FIG. 6 is a schematic flowchart of a power management method according to some embodiments of the present disclosure.

FIG. 7 is a schematic flowchart of a power management method according to some embodiments of the present disclosure.

FIG. 8 is a schematic flowchart of a power management method according to some embodiments of the present disclosure.

FIG. 9 is a schematic flowchart of a power management method according to some embodiments of the present disclosure.

FIG. 10 is a schematic flowchart of a power management method according to some embodiments of the present disclosure.

FIG. 11 is a schematic flowchart of a power management method according to some embodiments of the present disclosure.

FIG. 12 is a schematic flowchart of a power management method according to some embodiments of the present disclosure.

FIG. 13 is a schematic flowchart of a power management method according to some embodiments of the present disclosure.

FIG. 14 is a schematic block diagram of a power management device according to some embodiments of the present disclosure.

FIG. 15 is a schematic diagram showing a connection between a non-volatile computer-readable storage medium and a processor according to some embodiments of the present disclosure.

### DETAILED DESCRIPTION

Embodiments of the present disclosure will be described in detail below with reference to examples thereof as illustrated in accompanying drawings, throughout which same or similar elements, or elements having same or similar functions, are denoted by same or similar reference numerals. The embodiments described below with reference to the drawings are illustrative only, and are intended to explain, rather than limiting, the embodiments of the present disclosure.

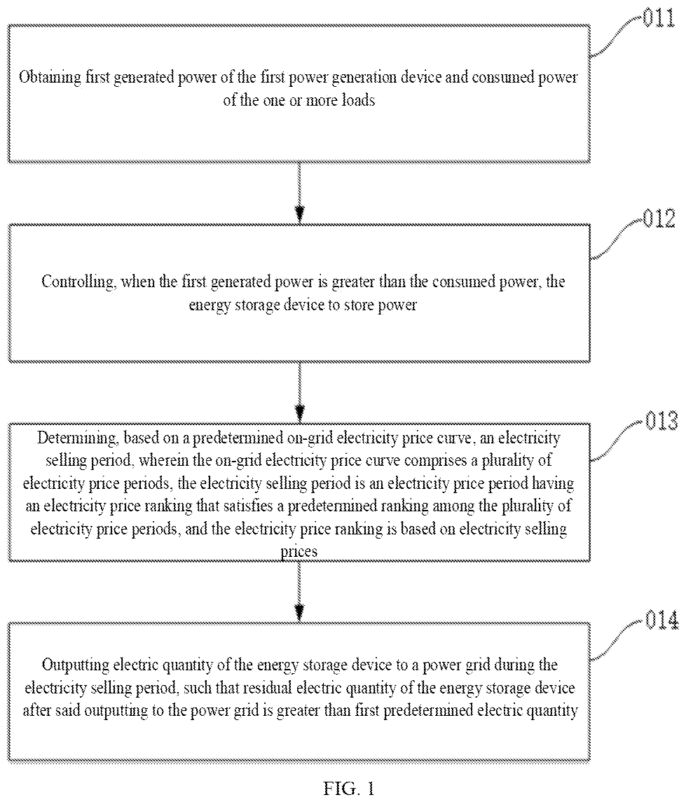

Referring to FIG. 1 to FIG. 4, a power management method according to the embodiments of the present disclosure is applied to an energy system 100. The energy system 100 includes a first power generation device 30, a power distribution device 40 and an energy storage device 50. The power distribution device 40 is connected to the first power generation device 30, the energy storage device 50 and one or more loads 200. The first power generation device 30 is configured to supply power to the power distribution device 40. The power management method includes operations at following blocks.

At block 011, first generated power of the first power generation device 30 and consumed power of the one or more loads 200 are obtained.

The energy system 100 includes the first power generation device 30, the power distribution device 40, the energy storage device 50, and an energy management device 70. The first power generation device 30 may be a device that generates power by using primary renewable energy, such as a solar power generation device, a wind power generation device, and the like. A plurality of the first power generation devices 30 may be provided (e.g., one or two first power generation devices 30 may be provided, etc.), and the number of the first power generation devices 30 may be configured based on actual requirements, which is not limited herein.

The power distribution device 40 may be a socket, a plug, an air switch, and the like. One or more power distribution devices 40 may be provided, which is not limited herein.

The energy storage device 50 may be an energy storage device or other devices capable of charging and discharging. For example, the energy storage device 50 may be a battery energy storage device, a capacitor energy storage device, etc. One or more energy storage devices 50 may be provided, which is not limited herein.

The energy management device 70 (Energy Management System, EMS) includes a processor 71 and a memory 72. The processor 71 can be connected to the power distribution device 40 for communication with the power distribution device 40.

In an exemplary embodiment of the present disclosure, by connecting the power distribution device 40 to the first power generation device 30, the first power generation device 30 can supply power to the power distribution device 40. Thus, the power distribution device 40 can collect the first generated power of the first power generation device 30 in real time.

In another exemplary embodiment of the present disclosure, since a position of the first power generation device 30 is fixed and weather conditions are basically similar, a variation condition of the first generated power at similar times is basically the same. Each day can be divided into several electricity consumption periods (Such as 12 electricity consumption periods, 24 electricity consumption periods, 48 electricity consumption periods, etc., it can be understood that the more the periods, the higher the accuracy of the estimation of the first generated power, and even each time point can be made an electricity consumption period). The first power generation device 30 has corresponding first generated power in each electricity consumption period. First generated power of a current electricity consumption period can be estimated by first generated power collected within a past predetermined time length (such as within a week, a month, etc.).

For example, after obtaining first generated power of the past week, first generated power of the first electricity consumption period of the day can be estimated based on first generated power of the first electricity consumption period of each day in the week. For example, an average of the first generated power of the first electricity consumption period of each day in the week is determined as the first generated power of the first electricity consumption period of the current day, realizing an estimation of the first generated power of each electricity consumption period.

By connecting the power distribution device 40 to the energy storage device 50, power generated by the first power generation device 30 can flow into the energy storage device 50 through the power distribution device 40, such that the power distribution device 40 can collect input power of the energy storage device 50. The energy storage device 50 has corresponding input power in each electricity consumption period. A collecting mode of input power of the current electricity consumption period may be estimated by using input power collected within the past predetermined time length (e.g., within a week, a month, etc.), or may be obtained by collecting input power in the current electricity consumption period in real time, such that the processor 71 can obtain the input power of the energy storage device 50.

The one or more loads 200 may be household appliances or devices capable of consuming electric energy. For example, the one or more loads 200 may be washing machines, electric lamps, etc. By connecting the power distribution device 40 to the one or more loads 200, the power generated by the first power generation device 30 can flow into the one or more loads 200 through the power distribution device 40. Therefore, the power distribution device 40 can collect consumed power of the one or more loads 200. The one or more loads 200 has corresponding consumed power in each electricity consumption period, such that a consumed power curve S1 can be drawn (e.g., within a week, a month, etc.). The consumed power of the current electricity consumption period can be estimated by using the consumed power collected within the past predetermined time length (e.g., within a week, a month, etc.), or the consumed power can be collected by the power distribution device 40 in real time during the current electricity consumption period. Therefore, the processor 71 can obtain the consumed power of the one or more loads 200.

At block 012, when the first generated power is greater than the consumed power, the energy storage device 50 is controlled to store power.

In an exemplary embodiment of the present disclosure, after obtaining the first generated power and the consumed power, the processor 71 compares the first generated power with the consumed power, and controls the energy storage device 50 to store power when the first generated power is greater than the consumed power. For example, by adjusting the input power of the energy storage device 50, when the consumed power of the one or more loads 200 is satisfied, the first power generation device 30 transmits excess power into the energy storage device 50 for storage.

In another exemplary embodiment of the present disclosure, the input power can be adjusted, such that a difference between the first generated power and total power of the one or more loads (i.e., a sum of the input power and the consumed power, at this time the energy storage device 50 is the one or more loads 200) is less than or equal to a predetermined threshold (The predetermined threshold is an empirical value, which can be determined based on electrical loss, such as the predetermined threshold can be 50 W, 100 W, etc.). For example, the first generated power is 10000 W, and the consumed power of the one or more loads 200 is 5000 W. Therefore, by setting the predetermined threshold to 50 W, the input power of the energy storage device 50 is adjusted to be ranging from 4950 W to 5000 W.

At block 013, based on a predetermined on-grid electricity price curve S3, an electricity selling period is determined. The on-grid electricity price curve S3 includes a plurality of electricity price periods. The electricity selling period is an electricity price period having an electricity price ranking that satisfies a predetermined ranking among the plurality of electricity price periods, and the electricity price ranking is based on an electricity selling price.

An on-grid electricity price is a price at which a public power grid 400 purchases electric quantity from a power generation company. The on-grid electricity price curve S3 is a curve formed by the on-grid electricity prices in different electricity consumption periods, and the on-grid electricity prices in different electricity consumption periods may be different.

In an exemplary embodiment of the present disclosure, the predetermined on-grid electricity price curve S3 can be predicted based on a historical on-grid electricity price. Since weekday electricity consumption and weekend electricity consumption is different, separate predictions are required. For example, historical on-grid electricity prices of the first three or five weekends before a current weekend are obtained. An average for each corresponding electricity price period of the first three weekends is taken as an on-grid electricity price of the corresponding electricity price period of the current weekend, such that the on-grid electricity price of each electricity price period of the current weekend can be obtained. In addition, the on-grid electricity price curve S3 of the current weekend can be drawn. By obtaining historical on-grid electricity prices of the first three or five weekdays before the current weekday, and taking an average for each corresponding electricity price period of the first three weekdays as an on-grid electricity price of the corresponding electricity price period of the current weekday, the on-grid electricity price of each electricity price period of the current weekday can be obtained. In addition, the on-grid electricity price curve S3 of the current weekday can be drawn.

The memory 72 can store the predetermined on-grid electricity price curve S3, and the processor 71 can determine the electricity selling period when the energy system 100 is in an on-grid state based on the predetermined on-grid electricity price curve S3. For example, the processor 71 can rank electricity selling prices of the plurality of electricity price periods from low to high within the plurality of electricity price periods included in the on-grid electricity price curve S3. Then the processor 71 can take an electricity price period having an electricity price ranking higher than the predetermined ranking as the electricity selling period.

For example, the processor 71 can divide 24 hours of a day into 12 electricity price periods, and each electricity price period includes 2 hours. The processor 71 can take an average of electricity selling prices in the 2 hours as an electricity selling price of a current electricity price period. Then the processor 71 ranks electricity selling prices of the 12 electricity price periods from low to high. When the predetermined ranking is set to a second place, the processor 71 can determine that the electricity selling period is the first place among a rank of the 12 electricity price periods. Or, when the predetermined ranking is set to a third place, the processor 71 can determine that the electricity selling period is the first and second place in a rank of the 12 electricity price periods.

In another exemplary embodiment of the present disclosure, when the current electricity price period has passed a highest electricity selling period of one day, the processor 71 can rank a highest electricity price period among remaining electricity price periods as the electricity selling period. For example, when the electricity price period of one day is 20 o'clock, the electricity selling price is the highest. But when the current electricity price period is 22 o'clock, and there is much electric quantity in the energy storage device 50 which needs to be sold at this time, the processor 71 takes an electricity price period having the highest ranking among the remaining electricity price periods as the electricity selling period to sell electricity.

At block 014, electric quantity of the energy storage device 50 is outputted to a power grid 400 during the electricity selling period, such that residual electric quantity of the energy storage device 50 after said outputting to the power grid 400 is greater than first predetermined electric quantity.

After determining the electricity selling period among the plurality of electricity price periods, the processor 71 can sell electric quantity stored in the energy storage device 50 to the public power grid 400 during the electricity selling period, such that the residual electric quantity of the energy storage device 50 after said selling is greater than the first predetermined electric quantity (e.g., the first predetermined electric quantity may be 50%, 70%, etc.). The first predetermined electric quantity may be determined based on a difference between electric quantity required by a target load 200 (a load 200 that requires to continuously operate is the target load 200) to operate for a predetermined time length (e.g., 1 hour, 2 hours, etc.) and the electric quantity generated by the first power generation device 30 during the predetermined time length.

In this way, the power management method is applied to the energy system 100, and the energy system 100 includes the first power generation device 30, the power distribution device 40, and the energy storage device 50. By connecting the power distribution device 40 to the first power generation device 30, the first power generation device 30 can supply power to the power distribution device 40. Then, by connecting the power distribution device 40 to the energy storage device 50 and the one or more loads 200, power generated by the first power generation device 30 is transmitted to the energy storage device 50 and the one or more loads 200, such that the first generated power of the first power generation device 30 and the consumed power of the one or more loads 200 can be obtained, and in turn whether the power generated by the first power generation device 30 can satisfy the one or more loads 200 can be learned. When the first generated power of the first power generation device 30 is greater than the consumed power of the one or more loads 200, i.e., when the power generated by the first power generation device 30 satisfies the consumed power of the one or more loads 200, there is still excess power. In this case, the energy storage device 50 can be controlled to store power (e.g., by adjusting the input power of the energy storage device 50), and the excess power generated by the first power generation device 30 can be stored in the energy storage device 50. In addition, an electricity selling price of each of the plurality of electricity price periods is ranked based on the predetermined on-grid electricity price curve S3, and electric quantity of the energy storage device 50 that is more than the first predetermined electric quantity is sold during the electricity price period having the electricity price ranking higher than the predetermined ranking. Compared with the situation in which the excess power generated by the first power generation device 30 can only be wasted or purchased by the public power grid 400 at a low price in the energy system 100 without energy storage device 50, the energy storage device 50 ensures that the power generated by the first power generation device 30 can be self-consumed as much as possible, and power from the public power grid 400 can be used as little as possible, which reduces household electricity cost.

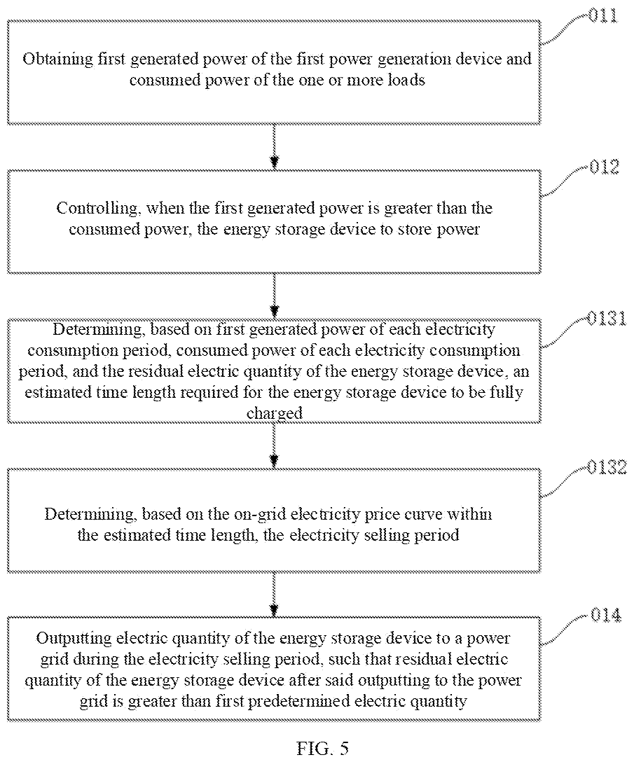

Referring to FIG. 5, in some embodiments, the operation at block 013 of determining the electricity selling period based on the predetermined on-grid electricity price curve S3 includes following operations at following blocks.

At block 0131, based on first generated power of each electricity consumption period, consumed power of each electricity consumption period, and the residual electric quantity of the energy storage device, an estimated time length required for the energy storage device to be fully charged is determined.

At block 0132, based on the on-grid electricity price curve within the estimated time length, the electricity selling period is determined.

In an exemplary embodiment of the present disclosure, the power distribution device 40 can collect the first generated power of the first power generation device 30 in each electricity consumption period, the consumed power of the one or more loads 200 in each electricity consumption period, and the residual electric quantity of the energy storage device 50. Therefore, the processor 71 can obtain the difference between the first generated power and the consumed power in each electricity consumption period, and determine the input power of the energy storage device 50 in each electricity consumption period. Then, the processor 71 can obtain electric quantity required for the energy storage device 50 to be fully charged based on the obtained the residual electric quantity of the energy storage device 50. Finally, the processor 71 can determine the estimated time length required for the energy storage device 50 to be fully charged based on the electric quantity required for the energy storage device 50 to be fully charged and the input power of each electricity consumption period. For example, the input power of each electricity consumption period is 5 kW, and the energy storage device 50 needs electric quantity of 20 kWh to be fully charged, such that the calculated estimated time length is equal to 20 kWh/5 KW which is equal to 4 hours, i.e., the energy storage device 50 is fully charged after 4 hours.

After the estimated time length is determined, in order to prevent the electric quantity from being wasted, the power needs to be sold within the estimated time length. the processor 71 can determine the electricity price period within the estimated time length based on the on-grid electricity price curve S3 within the estimated time length. For example, three electricity price periods are provided, the electricity selling prices within the estimated time length are ranked from low to high, and the electricity price period ranked higher than the predetermined ranking is select as the electricity selling period. For example, when the predetermined ranking is the second place, the electricity price period ranked first among three electricity price periods is determined to be the electricity selling period.

In this way, the estimated time length required for the energy storage device 50 to be fully charged is determined by using the first generated power of each electricity consumption period, the consumed power of each electricity consumption period, and the residual electric quantity of the energy storage device 50. The electricity selling period is determined by using the on-grid electricity price curve S3 within the estimated time length, which prevents a power generation waste caused by the first power generation device 30 continuing to generate power after the energy storage device 50 stores full electric quantity. In addition, profit for a user can also be increased.

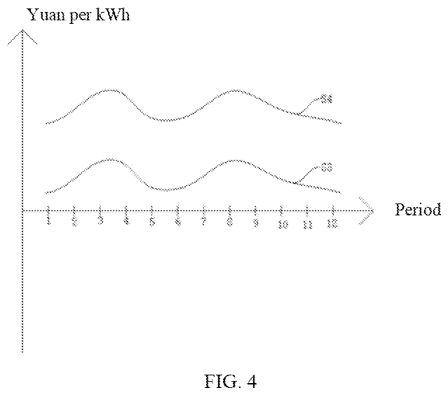

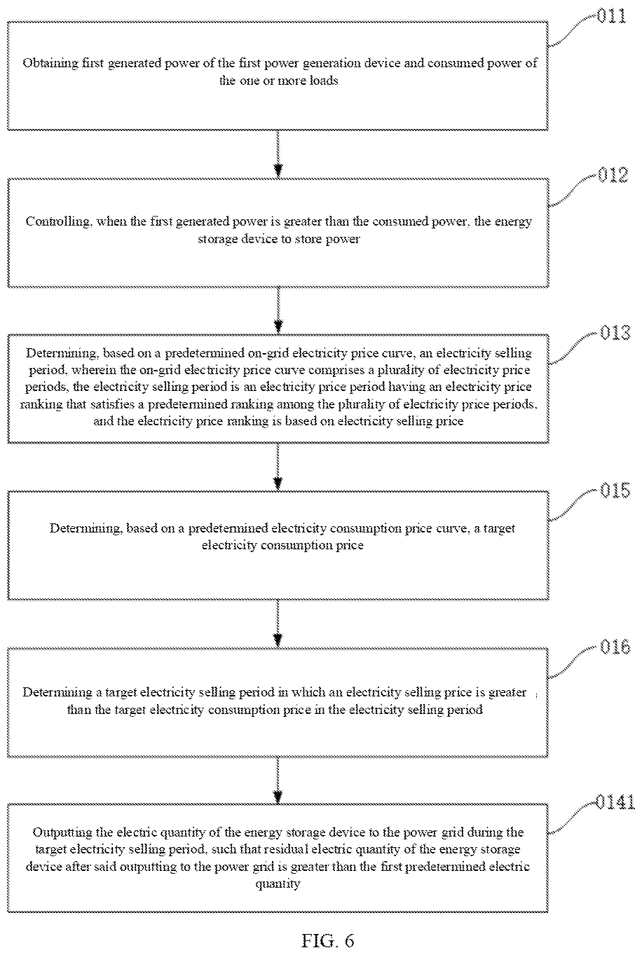

Referring again to FIG. 4 and FIG. 6, in some embodiments, the power management method further includes operations at following blocks.

At block 015, a target electricity consumption price is determined based on a predetermined electricity consumption price curve S4.

At block 016, a target electricity selling period in which an electricity selling price is greater than the target electricity consumption price in the electricity selling period is determined.

At block 014, the electric quantity of the energy storage device 50 is outputted to the power grid 400 during the electricity selling period, such that the residual electric quantity of the energy storage device 50 after said outputting to the power grid 400 is greater than the first predetermined electric quantity. This block includes operation at following block.

At block 0141, the electric quantity of the energy storage device 50 is outputted to the power grid 400 during the target electricity selling period, such that the residual electric quantity of the energy storage device 50 after said outputting to the power grid 400 is greater than the first predetermined electric quantity.

The electricity consumption price is a price required by the public power grid 400 to provide electric quantity to the consumer. The electricity consumption price curve S4 is a curve formed by the electricity consumption prices in different electricity consumption periods. In different electricity consumption periods, the electricity consumption price may be different, and the power generation cost of the first power generation device 30 is lower than the electricity consumption price of the public power grid 400.

In an exemplary embodiment of the present disclosure, the predetermined electricity consumption price curve S4 can be predicted based on the historical electricity consumption price. For example, historical electricity consumption prices in the first three or five weekends before a current weekend are obtained. An average for each corresponding electricity price period of the first three weekends is taken as an electricity consumption price in the corresponding electricity price period of the current weekend, such that the electricity consumption price in each electricity price period of the current weekend can be obtained. In addition, the electricity consumption price curve S4 of the current weekend can be drawn. By obtaining historical electricity consumption prices in the first three or five weekdays before a current weekday, and taking an average for each corresponding electricity price period of the first three weekdays as an electricity consumption price in the corresponding electricity price period of the current weekday, the electricity consumption price in each electricity price period of the current weekday can be obtained. In addition, the electricity consumption price curve S4 of the current weekday can be drawn.

The memory 72 can store the predetermined electricity consumption price curve S4, and the processor 71 can determine the target electricity consumption price based on the predetermined electricity consumption price curve S4 when the energy system 100 is in the on-grid state. For example, the processor 71 can divide 24 hours of one day into 12 electricity price periods, and each electricity price period includes 2 hours. An average of the electricity consumption price in the 2 hours is taken as the electricity consumption price in the current electricity price period. Then the processor 71 can rank the electricity consumption prices in the 12 electricity price periods based on the electricity consumption price curve S4 of the 12 electricity price periods. Finally, the processor 71 can determine that the target electricity consumption price is a maximum value of the electricity consumption prices in the 12 electricity price periods, or the target electricity consumption price is a median of the electricity consumption prices in the 12 electricity price periods, or the target electricity consumption price is an average value of the electricity consumption prices in the 12 electricity price periods, or, the target electricity consumption price is a minimum value of the electricity consumption prices in the 12 electricity price periods, or, the target electricity consumption price is a value of the electricity consumption price ranking at the 4th, 5th, etc. in the 12 electricity price periods.

After the processor 71 determines the electricity selling period, the processor 71 determines the electricity selling period in which the electricity selling price is greater than the target electricity consumption price in the electricity selling period as the target electricity selling period. Further, the processor 71 sells the electric quantity stored in the energy storage device 50 in the target electricity selling period, such that the residual electric quantity of the energy storage device 50 after said selling is greater than the first predetermined electric quantity (e.g., the first predetermined electric quantity may be 50%, 70%, etc.).

For example, the processor 71 can divide 24 hours of one day into 12 electricity price periods, and each period includes 2 hours. The processor 71 determines that the electricity selling period is two electricity price periods corresponding to 21 o'clock to 24 o'clock. The electricity selling price in the electricity price period corresponding to 21 o'clock to 22 o'clock is less than the target electricity consumption price, and the electricity selling price in the electricity price period corresponding to 23 o'clock to 24 o'clock is greater than the target electricity consumption price. The processor 71 can determine the electricity price period corresponding to 23 o'clock to 24 o'clock as the target electricity selling period, and then the processor 71 sells the portion that is more than 50% of the electric quantity stored in the energy storage device 50 in the electricity price period corresponding to 23 o'clock to 24 o'clock.

In another exemplary embodiment of the present disclosure, after the processor 71 determines the electricity selling period, when there is no electricity selling period in which the electricity selling price is greater than the target electricity consumption price, and then electricity selling is not performed. For example, the processor 71 determines that the electricity selling periods are two electricity price periods corresponding to 21 o'clock to 24 o'clock, but the electricity selling prices in the two electricity price periods are all less than the target electricity consumption price. Then the processor 71 does not sell electricity.

In this way, the target electricity consumption price is determined based on the predetermined electricity consumption price curve S4. The power stored in the energy storage device 50 having a portion greater than the first predetermined electric quantity is sold in the electricity selling period in which the electricity selling price is greater than the target electricity consumption price, thereby ensuring that the price at which electricity is sold is more reasonable and improves revenue for the customer.

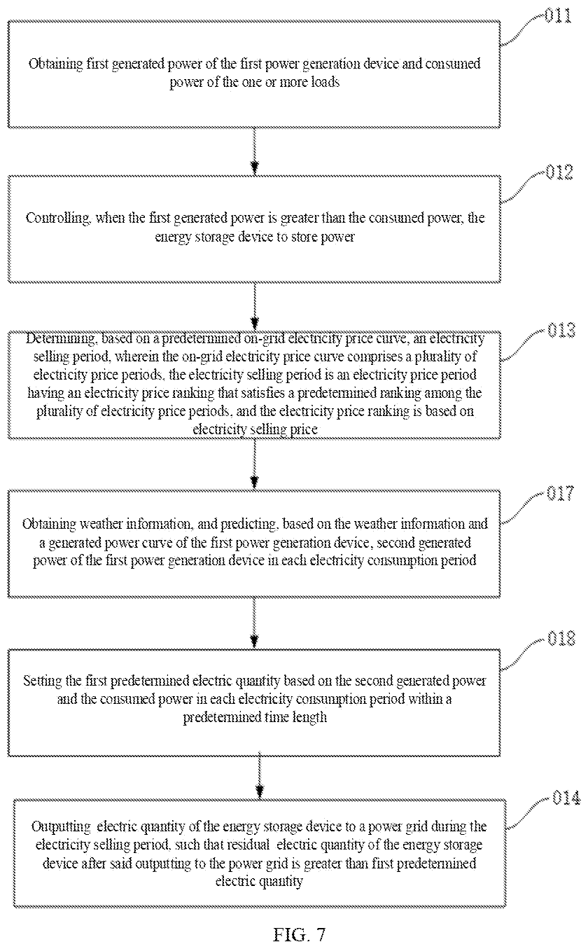

Referring again to FIG. 3 and FIG. 7, in some embodiments, the power management method further includes operations at following blocks.

At block 017, weather information is obtained, and based on the weather information and a generated power curve of the first power generation device 30, second generated power of the first power generation device 30 in each electricity consumption period is predicted.

At block 018, the first predetermined electric quantity is set based on the second generated power and the consumed power in each electricity consumption period within a predetermined time length.

The weather information may include solar illumination information, water level information, wind information, and the like.

In an exemplary embodiment of the present disclosure, a generated power curve S2 is generated based on the estimated first generated power in each electricity consumption period. For an estimation method of the first generated power in each electricity consumption period, it can refer to descriptions at block 011, which is not described here.

The processor 71 obtains weather information and predicts second generated power of the first power generation device 30 in each electricity consumption period based on the obtained weather information and the generated power curve S2 of the first power generation device 30. It should be understood that the generated power curve S2 is a curve of the first generated power. Since weather affects the generated power of the first power generation device 30, the generated power curve S2 can be adjusted based on the weather information. For example, for the first power generation device 30 of solar power generation, cloudy weather may cause the generated power of the first power generation device 30 to decrease. Therefore, it is necessary to correspondingly adjust the generated power curve S2 to obtain a generated power curve S5 corresponding to the second generated power, and the second generated power in each electricity consumption period may be obtained based on the generated power curve S5.

The processor 71 is then able to set the first predetermined electric quantity based on the second generated power and the consumed power in each electricity consumption period within the predetermined time length (the predetermined time length may be 4 hours, 12 hours, 24 hours, etc.). For example, the processor 71 may calculate electric quantity consumption and electric quantity generation in the predetermined time length based on the second generated electric quantity and the consumed electric quantity in each electricity consumption period within the predetermined time length. The processor 71 may determine the first predetermined electric quantity based on the difference between the power consumption and the power generation. For example, the first predetermined electric quantity is the difference, and in the case where the difference is negative, the first predetermined electric quantity is 0%. In this way, the reserved electric quantity of the energy storage device 50 can be ensured to meet a power demand within the predetermined time length without using the power of the public power grid 400, and self-use can be realized.

For example, when the first power generation device 30 uses the solar power generation, the first predetermined electric quantity may be set to a small ratio such as 0% or 5% in weather with much illumination, such as sunny weather, and the first predetermined electric quantity may be set to a large ratio such as 50% or 70% in weather with insufficient illumination, such as cloudy weather. For another example, in the case where the first power generation device 30 uses wind power generation, the first predetermined electric quantity may be set to a small ratio such as 0% or 5% in weather with strong wind, such as windy weather, and the first predetermined electric quantity may be set to a large ratio such as 50% or 70% in weather with light wind, such as breeze weather. For example, in the case where the first power generation device 30 uses hydroelectric power generation, the first predetermined electric quantity may be set to a small ratio such as 0% or 5% in weather with much water, such as rainy weather, and the first predetermined electric quantity may be set to a large ratio such as 50% or 70% in weather with little water, such as sunny or cloudy weather.

In this way, by obtaining the weather information and the generated power curve S2 of the first power generation device 30, the second generated power of the first power generation device 30 is predicted. In addition, the first predetermined electric quantity is set based on the second generated power and the consumed power in each electricity consumption period within the predetermined time length. In this way, self-generation and self-consumption of electric quantity can be realized, and the excess electric quantity in the energy storage device 50 can be sold, thereby increasing the revenue of the user.

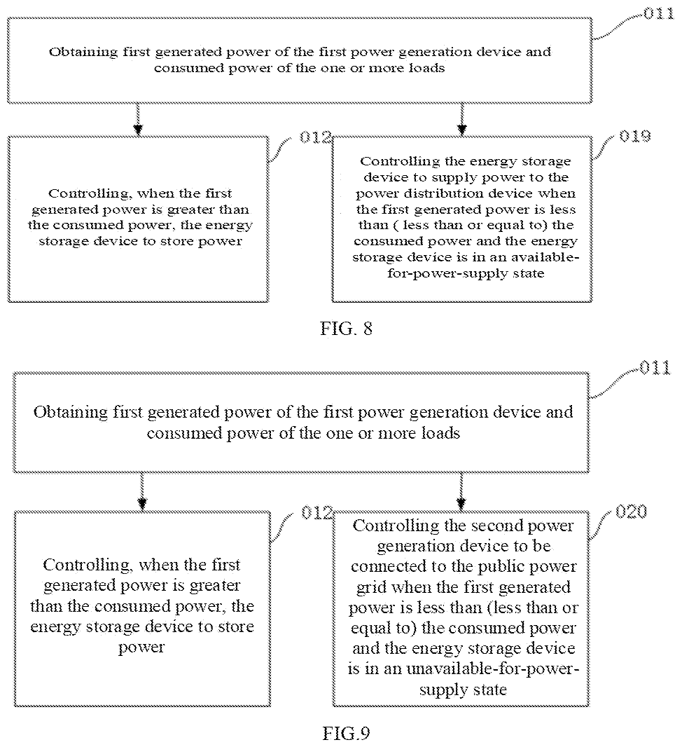

Referring to FIG. 8, in some embodiments, the power management method further includes operations at following blocks.

At block 019, the energy storage device 50 is controlled to supply power to the power distribution device 40 when the first generated power is less than the consumed power and the energy storage device 50 is in an available-for-power-supply state. The energy storage device 50 being in the available-for-power-supply state includes that the residual electric quantity of the energy storage device 50 is greater than second predetermined electric quantity.

In an exemplary embodiment of the present disclosure, when the residual electric quantity of the energy storage device 50 is greater than the second predetermined electric quantity (e.g., the second predetermined electric quantity may be 40%, 50%, etc.), the energy storage device 50 is in the available-for-power-supply state. In this case, the energy storage device 50 can supply power to the power distribution device 40. When the first generated power is less than (or equal to) the consumed power and the energy storage device 50 is in the available-for-power-supply state, the processor 71 can control the energy storage device 50 to supply power to the power distribution device 40. Thus, the power distribution device 40 can transmit electric quantity to the one or more loads 200. For example, when the first power generation device 30 does not generate enough electric quantity to satisfy a demand of the one or more loads 200, the processor 71 can adjust the output power of the energy storage device 50 in the available-for-power-supply state to supply the electric quantity stored in the energy storage device 50 to the power distribution device 40, so that the power distribution device 40 can supply electric quantity to the one or more loads 200 to satisfy the demand of the one or more loads 200.

In this way, by controlling the energy storage device 50 to supply power to the power distribution device 40 when the first generated power is less than the consumed power and the energy storage device 50 is in the available-for-power-supply state, the electric quantity purchased by the user from the public power grid 400 can be reduced, and the cost of the user can be reduced.

Referring to FIG. 9, in some embodiments, the energy system 100 further includes a second power generation device 60 configured to supply power to the power distribution device 40. The method further includes operations at following block.

At block 020, the second power generation device 60 is controlled to generate power or the power distribution device 40 is controlled to connected to a public power grid 400 when the first generated power is less than the consumed power and the energy storage device 50 is in an unavailable-for-power-supply state. A power generation cost of the second power generation device 60 is greater than a power generation cost of the first power generation device 30. The energy storage device 50 being in the unavailable-for-power-supply state includes that the residual electric quantity of the energy storage device 50 is less than third predetermined electric quantity.

The second power generation device 60 is a device configured to generate power by using non-renewable resources in primary energy sources or secondary energy sources, such as a fuel generator and a natural gas generator.

In an exemplary embodiment of the present disclosure, the energy system 100 further includes a second power generation device 60 capable of supplying power to the power distribution device 40. The energy storage device 50 is provided with third predetermined electric quantity. The third predetermined electric quantity (e.g., the third predetermined electric quantity may be 5%, 10%, etc.) may be electric quantity required by the target load 200 (e.g., the load 200 that need to continuously operate). When the residual electric quantity of the energy storage device 50 is less than the third predetermined electric quantity, the energy storage device 50 is in the unavailable-for-power-supply state. When the energy storage device 50 is in the unavailable-for-power-supply state, power can only be supplied to the target load 200, and cannot be supplied to the one or more loads 200 other than the target load 200, which only ensures the continuous operation of the target load 200.

In this case, when the first generated power is less than (or equal to) the consumed power and the energy storage device 50 is in the unavailable-for-power-supply state, the processor 71 can control the second power generation device 60 to generate power or control the power distribution device 40 to be connected to the public power grid 400. In this way, the power distribution device 40 can transmit electric quantity to the one or more loads 200. The power generation cost of the second power generation device 60 is greater than the power generation cost of the first power generation device 30, and the power generation cost of the first power generation device 30 is lower than the electricity consumption price of the public power grid 400. For example, when the electric quantity generated by the first power generation device 30 does not meet the demand of the one or more loads 200 and the energy storage device 50 is in the unavailable-for-power-supply state, the processor 71 can control the second power generation device 60 to generate power or control the power distribution device 40 to be connected to the public power grid 400, and power can be supplied to the power distribution device 40 through the second power generation device 60 or the public power grid 400, such that the power distribution device 40 can supply electric quantity to the one or more loads 200 to satisfy the demand of the one or more loads 200.

In this way, when the first generated power is less than the consumed power and the energy storage device 50 is in the unavailable-for-power-supply state, the second power generation device 60 is controlled to generate power or the power distribution device 40 is controlled to be connected to the public power grid 400. Therefore, power is supplied to the power distribution device 40 through the second power generation device 60 or the public power grid 400, and the electric quantity demand required by the one or more loads 200 can be met.

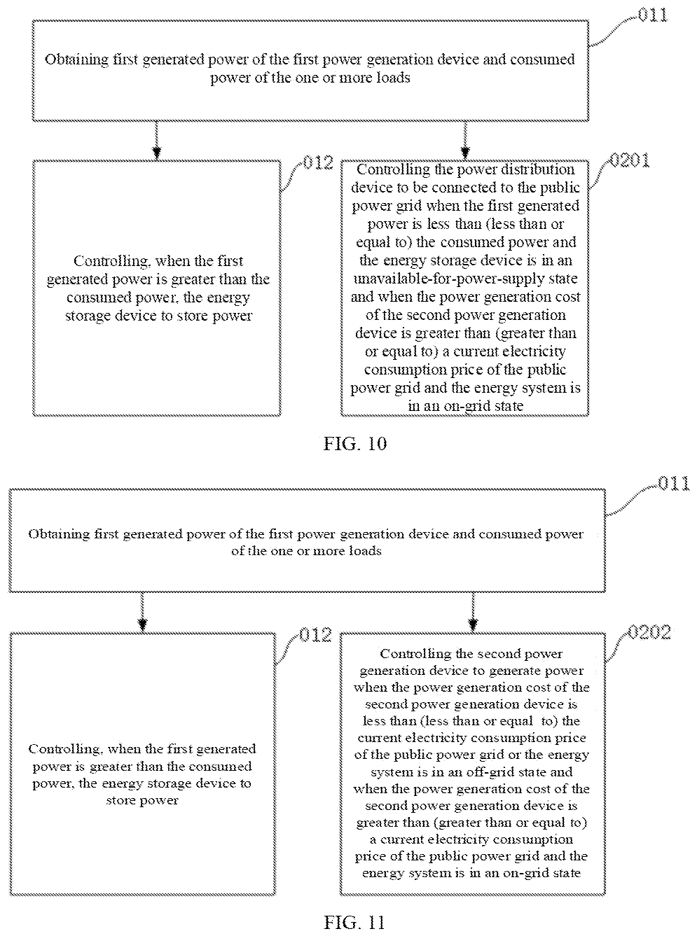

Referring to FIG. 10 and FIG. 11, in some embodiments, operations at the block 020 of controlling the second power generation device 60 to generate power or controlling the power distribution device 40 to be connected to the public power grid 400 include operations at following blocks.

At block 0201, the power distribution device 40 is controlled to be connected to the public power grid 400 when the power generation cost of the second power generation device 60 is greater than a current electricity consumption price of the public power grid 400 and the energy system is in an on-grid state.

At block 0202, the second power generation device 60 is controlled to generate power when the power generation cost of the second power generation device 60 is less than the current electricity consumption price of the public power grid 400 or the energy system 100 is in an off-grid state.

In an exemplary embodiment of the present disclosure, when the electric quantity generated by the first power generation device 30 and the energy storage device 50 are in the unavailable-for-power-supply state, the processor 71 can control the second power generation device 60 to generate power or control the power distribution device 40 to be connected to the public power grid 400. For example, when the power generation cost of the second power generation device 60 is greater than (or equal to) the current electricity consumption price of the public power grid 400 and the energy system 100 is in the on-grid state, the power consumption cost of connecting to the public power grid 400 is obviously lower, and the processor 71 can control the power distribution device 40 to be connected to the public power grid 400, and the electric quantity supplied by the public power grid 400 is used to meet the demand of the one or more loads 200. When the power generation cost of the second power generation device 60 is less than (or equal to) the current electricity consumption price of the public power grid 400, the power consumption cost of connecting to the public power grid 400 is obviously higher, and the power consumption cost of generating electricity by using the second power generation device 60 is lower. The processor 71 can control the second power generation device 60 to generate power, and the electric quantity supplied by the second power generation device 60 is used to meet the demand of the one or more loads 200. Alternatively, when the energy system 100 is in an off-grid state (the off-grid state is that the energy system 100 is not connected to the public power grid 400), since the public power grid 400 cannot be used for power supply in this case, the processor 71 can only control the second power generation device 60 to generate power, and the electric quantity supplied by the second power generation device 60 is used to meet the demand of the one or more loads 200.

In this way, the processor 71 controls the power distribution device 40 to be connected to the public power grid 400 to supply power to the one or more loads 200 or controls the second power generation device 60 to generate power to supply power to the one or more loads 200. Therefore, a lowest power consumption cost can be realized. The power supply demand by the one or more loads 200 can be satisfied, and at the same time, the power consumption cost can be saved for the user.

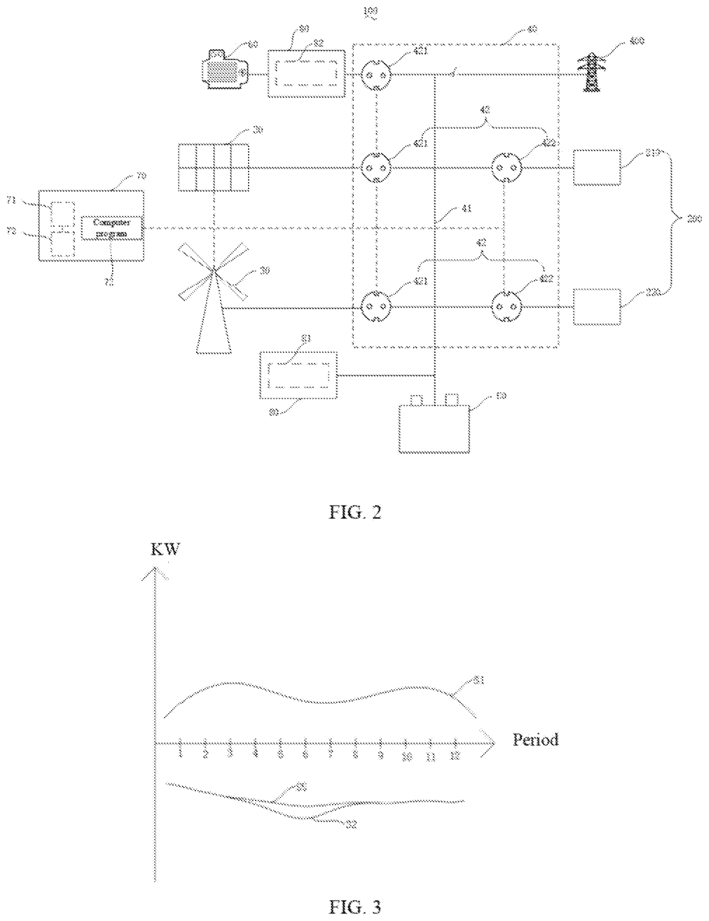

Referring again to FIG. 2, in some embodiments, the energy system 100 further includes a second power generation device 60 having a power generation cost greater than a power generation cost of the first power generation device 30. The power distribution device 40 includes a power supply circuit 41 and a switch 42. The power supply circuit 41 is connected to the switch 42, and the switch 42 is connected to the one or more loads 200. The switch 42 is configured to control on/off of the one or more loads 200. Each of the first power generation device 30 and the second power generation device 40 is configured to supply power to the power supply circuit 41.

In an exemplary embodiment of the present disclosure, the power generation cost of the second power generation device 60 included in the energy system 100 is greater than the power generation cost of the first power generation device 30. The power distribution device 40 includes the power supply circuit 41 and the switch 42. The power supply circuit 41 can be connected to the switch 42, the first power generation device 30, and the second power generation device 60. The switch 42 can be an intelligent socket. The switch 42 is connected to the one or more loads 200, and can control on/off of the corresponding one or more loads 200. The first power generation device 30 and the second power generation device 60 are capable of supplying power to the power supply circuit 41, and the power supply circuit 41 then supplies power to the one or more loads 200 corresponding to the switch 42 in an on-state.

Referring again to FIG. 2, in some embodiments, the loads 200 include a first load 210 and a second load 220. The switch 42 is configured to keep the first load 210 in a power-on state in each electricity consumption period, keep the second load 220 in a power-on state in an electricity consumption period in which an electricity consumption price is less than a predetermined power price threshold, and keep the second load 220 in a power-off state in an electricity consumption period in which the electricity consumption price is greater than the predetermined power price threshold. The first load 210 has a higher real-time requirement than the second load 220.

In an exemplary embodiment of the present disclosure, the loads 200 include the first load 210 and the second load 220, and the real-time requirement of the first load 210 is greater than the real-time requirement of the second load 220. For example, the first load 210 is a device that cannot be time-shifted, such as the device that needs to operates immediately when it is needed. For example, the first load 210 may be a lighting lamp, a refrigerator, etc. Therefore, the first load 210 is kept in a power-on state in each electricity consumption period, which can ensure that the first load 210 operates immediately when it is needed, ensuring user experience. The second load 220 may be a time-shifted device, such as, the device that can ensure normal use when operating at any time. For example, the second load 220 may be a water heater, which can heat at any time, and can be used by a user at any time due to a heat preservation function. Therefore, the second load 220 is in the power-on state during the electricity consumption period in which the electricity consumption price is less than the predetermined power price threshold (the predetermined power price threshold may be the average of the electricity consumption prices in each electricity price period), which ensures that a power consumption cost of the second load 220 is reduced during operation and in turn benefits to saving electricity costs.

In this way, by setting power consumption timeliness of the first load 210 and the second load 220, the processor 71 can determine the first load 210 in the plurality of loads 200 and the second load 220 in the plurality of loads 200, facilitating the processor 71 to control on-off of the first load 210 and the second load 220.

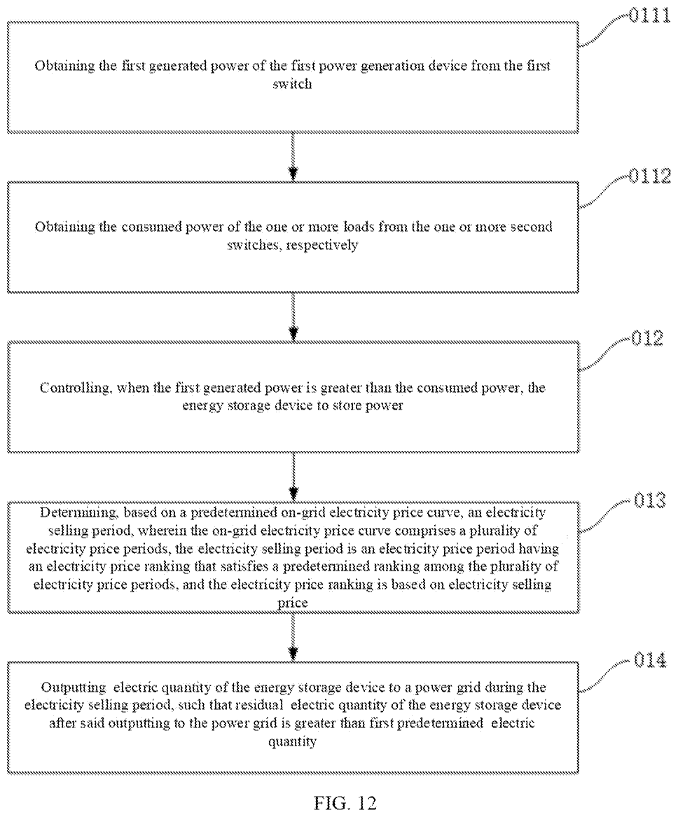

Referring to FIG. 2 and FIG. 12, in some embodiments, the power distribution device 40 further includes a first switch 421 and one or more second switches 422. The first switch 421 is connected to the first power generation device 30, and the one or more second switches 422 are connected to the one or more loads 200, respectively. The operation at block 011 of obtaining the first generated power of the first power generation device 30 and the consumed power of the one or more loads 200 includes following operations at blocks.

At block 0111, the first generated power of the first power generation device 30 is obtained from the first switch.

At block 0112, the consumed power of the one or more loads 200 is obtained from the one or more second switches 422, respectively.

In an exemplary embodiment of the present disclosure, the power distribution device 40 further includes the first switch 421 and the second switch 422. The first switch 421 and the second switch 422 may be intelligent sockets. The first switch 421 can be electrically connected to the first power generation device 30 or the first switch 421 can be electrically connected to the second power generation device 60, thereby enabling the first switch 421 to obtain the first generated power of the first power generation device 30 or enabling the first switch 421 to obtain the second generated power of the second power generation device 60.

One or more second switches 422 may be provided, which is not limited herein. The one or more second switches 422 can be electrically connected to the one or more loads 200, such that the second switch 422 can obtain the consumed power of one or more loads 200.

In this way, by connecting the first switch 421 to the first power generation device 30, the first generated power of the first power generation device 30 can be accurately obtained. By connecting the second switch 422 to the load 200, the consumed power of the load 200 can be accurately obtained.

Referring to FIG. 2, in some embodiments, the energy management unit 80 may include a first energy management unit 81 having an independent structure and being electrically connected to a power supply circuit 41.

In an exemplary embodiment of the present disclosure, the first energy management unit 81 can be mounted at an external environment and connected to the first power generation device 30, the first switch 421, the second switch 422, and the like through wired connection or wireless connection. Therefore, data of the first power generation device 30, the first switch 421, the second switch 422, and the like are transmitted to the energy management unit 80, thereby enabling the first energy management unit 81 to analyze the received data and output a control strategy. The first energy management unit 81 is independently arranged outside the first power generation device 30, which can improve expandability of the energy system 100. For example, when it is necessary to expand the devices (such as the first power generation device 30, the first switch 421, and the second switch 422) in the energy system 100, it is only necessary to establish communication between the expanding devices and the first energy management unit 81, and the energy system 100 can be used normally. In addition, when the first energy management unit 81 is independently arranged outside the first power generation device 30, and the first energy management unit 81 can be controlled and managed independently from the first power generation device 30, the first switch 421, the second switch 422, and other devices. In this way, flexibility of the first energy management unit 81 can be improved. The external first energy management unit 81 can select suitable devices such as the first power generation device 30 based on actual needs for control and management to achieve a reasonable allocation of energy in the energy system 100.

Referring to FIG. 2, in some embodiments, the energy management unit 80 may include a second energy management unit 82 integrated into the first power generation device 30.

In an exemplary embodiment of the present disclosure, the second energy management unit 82 can be connected to the first power generation device 30, the first switch 421, the second switch 422, and the like through wired connection or wireless connection. Thus, the data of the first power generation device 30, the first switch 421, the second switch 422, and the like can be transmitted to the second energy management unit 82, thereby enabling the second energy management unit 82 to analyze the received data and output the control strategy. The second energy management unit 82 is integrated into the first power generation device 30, which not only simplifies a structure of the energy system 100 by avoiding additional mounting and wiring work, but also improves a speed at which the second energy management unit 82 receives data and improves a response efficiency of the second energy management unit 82.

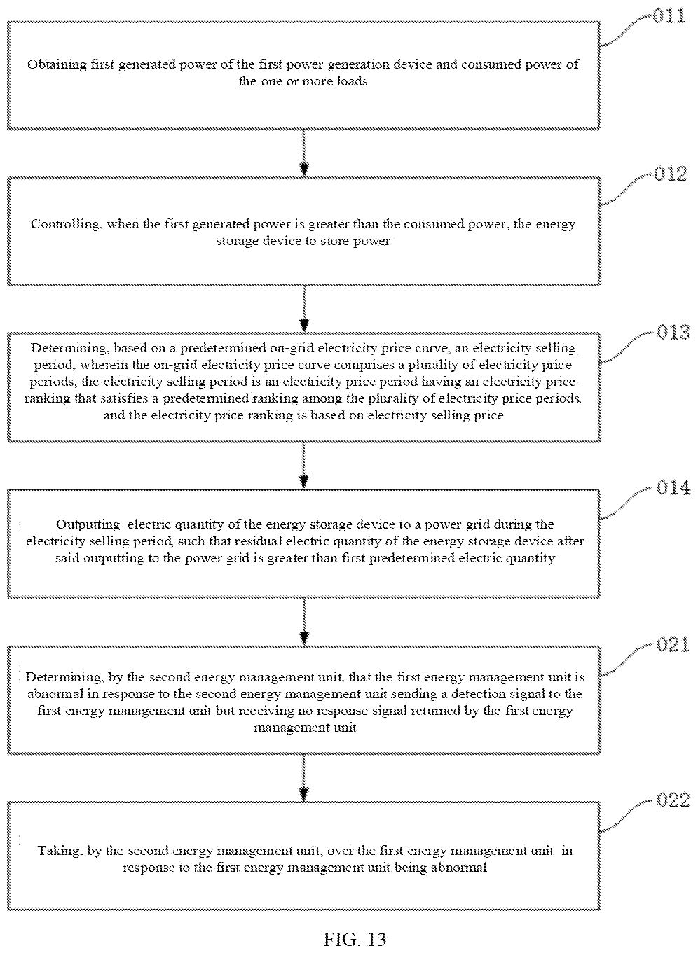

Referring to FIG. 2 to FIG. 13, in some embodiments, each of the first energy management unit 81 and the second energy management unit 82 is configured to analyze received data and output a control strategy. The power management method includes operations at blocks.

At block 021, the second energy management unit 82 determines that the first energy management unit 81 is abnormal in response to the second energy management unit 82 sending a detection signal to the first energy management unit 81 but receiving no response signal returned by the first energy management unit 81.

At block 022, the second energy management unit 82 takes over the first energy management unit 81 in response to the first energy management unit 81 being abnormal.

In an exemplary embodiment of the present disclosure, the energy system 100 includes the first energy management unit 81 and the second energy management unit 82. Each of the first energy management unit 81 and the second energy management unit 82 is configured to analyze the received data and output the control strategy. The first energy management unit 81 and the second energy management unit 82 are capable of detecting each other to determine whether an operating state of each other is normal. For example, one of the first energy management unit 81 and the second energy management unit 82 transmits a detection signal to the other and receives a response signal returned by the other and the response signal is used for determining whether the other of the first energy management unit 81 and the second energy management unit 82 is abnormal. If the second energy management unit 82 transmits a detection signal to the first energy management unit 81 but receives no response signal returned from the first energy management unit 81, the second energy management unit 82 can determine that the first energy management unit 81 is abnormal (e.g., down). Therefore, the second energy management unit 82 can take over the operation of the first energy management unit 81. That is, in this case, the second energy management unit 82 is capable of: obtaining total output power of the first power generation device 30 and total output power of the second power generation device 60; obtaining the consumed power of each of the one or more loads 200 to obtain total consumed power of the one or more loads 200; and at least partially adjusting output power based on the total output power and the total consumed power. In this way, a problem that the energy system 100 cannot operate when the first energy management unit 81 is abnormal can be prevented and stability of the energy system 100 can be improved.

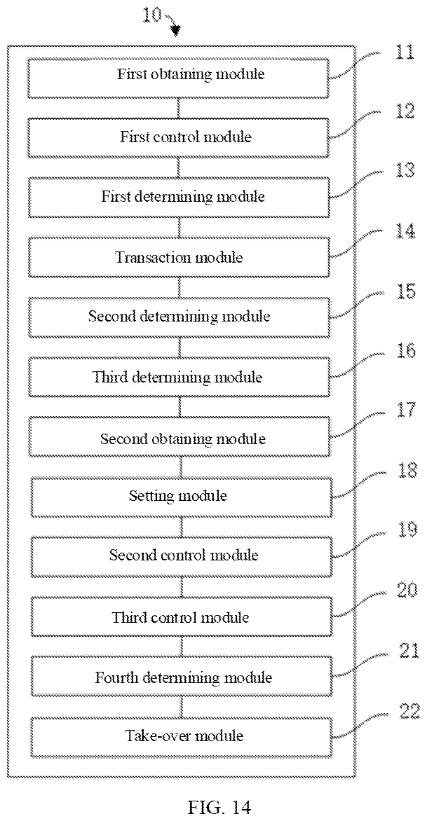

Referring again to FIG. 2 and FIG. 14, according to the embodiments of the present disclosure, the power management device 10 is applied to an energy system 100. The energy system 100 includes a first power generation device 30, a power distribution device 40, and an energy storage device 50. The power distribution device 40 is connected to the first power generation device 30, the energy storage device 50, and one or more loads 200. The first power generation device 30 is configured to supply power to the power distribution device 40. The power management device 10 includes a first obtaining module 11, a first control module 12, and a first determining module 13. The first obtaining module 11 is configured to obtain first generated power of the first power generation device 30 and consumed power of the one or more loads 200. The first control module 12 is configured to control, when the first generated power is greater than the consumed power, the energy storage device 50 to store power. The first determining module 13 is configured to determine, based on a predetermined on-grid electricity price curve S3, an electricity selling period. The on-grid electricity price curve S3 includes a plurality of electricity price periods. The electricity selling period is an electricity price period having an electricity price ranking that satisfies a predetermined ranking among the plurality of electricity price periods, and the electricity price ranking is based on an electricity selling price. A transaction module 14 is configured to output electric quantity of the energy storage device 50 to a power grid 400 during the electricity selling period, such that residual electric quantity of the energy storage device 50 after said outputting to the power grid 400 is greater than first predetermined electric quantity.

The first determining module 13 is specifically configured to determine the estimated time length required for the energy storage device 50 to be fully charged based on the first generated power of each electricity consumption period, the consumed power of each electricity consumption period, and the residual electric quantity of the energy storage device 50, and determine the electricity selling period based on the on-grid electricity price curve S3 within the estimated time length.

The power management device 10 further includes a second determining module 15 configured to determine a target electricity consumption price based on the predetermined electricity consumption price curve S4.

The power management device 10 further includes a third determining module 16 configured to determine a target electricity selling period in which the electricity selling price is greater than the target electricity consumption price in the electricity selling period.

The transaction module 14 is specifically configured to output the electric quantity of the energy storage device 50 to the power grid 400 during the target electricity selling period, such that the residual electric quantity of the energy storage device 50 after said outputting to the power grid 400 is greater than the first predetermined electric quantity.

The power management device 10 further includes a second obtaining module 17 configured to obtain weather information, and predict, based on the weather information and a generated power curve S2 of the first power generation device 30, second generated power of the first power generation device 30 in each electricity consumption period.

The power management device 10 further includes a setting module 18 configured to set the first predetermined electric quantity based on the second generated power and the consumed power in each electricity consumption period within a predetermined time length.

The power management device 10 further includes a second control module 19 configured to control the energy storage device 50 to supply power to the power distribution device 40 when the first generated power is less than the consumed power and the energy storage device 50 is in an available-for-power-supply state. The energy storage device 50 being in the available-for-power-supply state includes that the residual electric quantity of the energy storage device 50 is greater than second predetermined electric quantity.

The power management device 10 further includes a third control module 20 configured to control the second power generation device 60 to generate power or control the power distribution device 40 to be connected to public power grid 400 when the first generated power is less than the consumed power and the energy storage device 50 is in an unavailable-for-power-supply state. A power generation cost of the second power generation device 60 is greater than a power generation cost of the first power generation device 30. The energy storage device 50 being in the unavailable-for-power-supply state includes that the residual electric quantity of the energy storage device 50 is less than third predetermined electric quantity.

The third control module 20 is specifically configured to control the power distribution device 40 to be connected to the public power grid 400 when the power generation cost of the second power generation device 60 is greater than the current electricity consumption price of the public power grid 400 and the energy system 100 is in an on-grid state. When the power generation cost of the second power generation device 60 is less than the current electricity consumption price of the public power grid 400 or the energy system 100 is in an off-grid state, the third control module 20 is configured to control the second power generation device 60 to generate power.

The first obtaining module 11 is specifically configured to obtain the first generated power of the first power generation device 30 from the first switch 421, and obtain the consumed power of one or more loads 200 from one or more second switches 422, respectively.

The power management device 10 further includes a fourth determining module 21 configured to determine by the second energy management unit 82 that the first energy management unit 81 is abnormal in response to the second energy management unit 82 sending a detection signal to the first energy management unit 81 but receiving no response signal returned by the first energy management unit 81.

The power management device 10 further includes take-over module 22 configured to take over the first energy management unit 81 by the second energy management unit 82 in response to the first energy management unit 81 being abnormal.

Referring to FIG. 2 again, according to the embodiments of the present disclosure, the energy management device 70 includes a processor 71 and a memory 72 storing a computer program 73. The computer program 73, when executed by the processor 71, implements the operations of the power management method of any of the above embodiments, which is not repeated here for brevity.

Referring to FIG. 2 again, according to the embodiments of the present disclosure, the energy system 100 includes a first power generation device 30, a power distribution device 40, an energy storage device 50, and the energy management device 70. The energy management device 70 is connected to the first power generation device 30, the power distribution device 40, and the energy storage device 50, and the power distribution device 40 is connected to the first power generation device 30, the energy storage device 50, and the one or more loads 200.

In an exemplary embodiment of the present disclosure, the energy system 100 includes the first power generation device 30, the power distribution device 40, the energy storage device 50, and the energy management device 70. The energy management device 70 can be connected to the first power generation device 30. Thus, the energy management device 70 can obtain the generated power of the first power generation device 30. The energy management device 70 can be connected to the power distribution device 40 and the energy storage device 50. Thus, the energy management device 70 can control the power distribution device 40 to transmit electric quantity to the energy storage device 50. By connecting the power distribution device 40 to the first power generation device 30, the energy storage device 50, and the one or more loads 200, the electric quantity generated by the first power generation device 30 can be transmitted to the energy storage device 50 and the one or more loads 200 through the power distribution device 40.

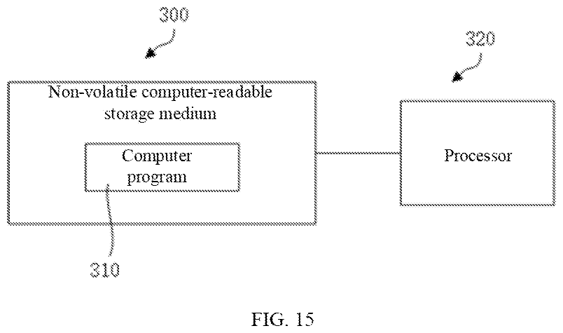

Referring to FIG. 15, a computer-readable storage medium 300 storing a computer program 310 is further provided by the embodiments of the present disclosure. When the computer program 310 is executed by a processor 320, operations of the power management method of any of the above embodiments can be implemented, which is not repeated here for brevity.

In the description of this specification, description with reference to the terms “some embodiments”, “an example”, “as an example” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, different embodiments or examples and features of different embodiments or examples described in the specification may be combined by those skilled in the art without mutual contradiction.

Any process or method described in a flowchart or described herein in other ways may be understood to include one or more modules, segments, or portions of codes of executable instructions for achieving specific logical functions or operations in the process. The scope of a preferred embodiment of the present disclosure includes other implementations. A function may be performed in a sequence not shown or discussed, including a substantially simultaneous manner or a reverse sequence based on the function involved, which should be understood by those skilled in the art to which the embodiments of the present disclosure belong.

Although embodiments of the present disclosure have been shown and described above, it should be understood that the above embodiments are merely exemplary, and cannot be construed as limitations of the present disclosure. For those skilled in the art, changes, modifications, alternatives, and variant can be made to the above embodiments without departing from the scope of the present disclosure.

What is claimed is:

1. A power management method, applied to an energy system, wherein the energy system comprises a first power generation device, a power distribution device, and an energy storage device, the power distribution device being connected to the first power generation device, the energy storage device and one or more loads, and the first power generation device being configured to supply power to the power distribution device, and the power management method comprises:
obtaining first generated power of the first power generation device and consumed power of the one or more loads;
controlling, when the first generated power is greater than the consumed power, the energy storage device to store power;
determining, based on a predetermined on-grid electricity price curve, an electricity selling period, wherein the on-grid electricity price curve comprises a plurality of electricity price periods, the electricity selling period is an electricity price period having an electricity price ranking that satisfies a predetermined ranking among the plurality of electricity price periods, and the electricity price ranking is based on an electricity selling price; and
outputting electric quantity of the energy storage device to a power grid during the electricity selling period, such that residual electric quantity of the energy storage device after said outputting to the power grid is greater than first predetermined electric quantity.

2. The power management method according to claim 1, wherein said determining, based on the predetermined on-grid electricity price curve, the electricity selling period comprises:
determining, based on first generated power of each electricity consumption period, consumed power of each electricity consumption period, and the residual electric quantity of the energy storage device, an estimated time length required for the energy storage device to be fully charged; and
determining, based on the on-grid electricity price curve within the estimated time length, the electricity selling period.

3. The power management method according to claim 1, further comprising:
determining, based on a predetermined electricity consumption price curve, a target electricity consumption price; and
determining a target electricity selling period in which an electricity selling price is greater than the target electricity consumption price in the electricity selling period;
wherein said outputting the electric quantity of the energy storage device to the power grid during the electricity selling period, such that the residual electric quantity of the energy storage device after said outputting to the power grid is greater than the first predetermined electric quantity comprises:
outputting the electric quantity of the energy storage device to the power grid during the target electricity selling period, such that the residual electric quantity of the energy storage device after said outputting to the power grid is greater than the first predetermined electric quantity.

4. The power management method according to claim 3, wherein:
the on-grid electricity price curve is predicted based on a historical on-grid electricity price; and
the electricity consumption price curve is predicted based on a historical electricity consumption price.

5. The power management method according to claim 2, further comprising:
obtaining weather information, and predicting, based on the weather information and a generated power curve of the first power generation device, second generated power of the first power generation device in each electricity consumption period; and
setting the first predetermined electric quantity based on the second generated power and the consumed power in each electricity consumption period within a predetermined time length.

6. The power management method according to claim 1, further comprising:
controlling the energy storage device to supply power to the power distribution device when the first generated power is less than the consumed power and the energy storage device is in an available-for-power-supply state,
wherein said the energy storage device being in the available-for-power-supply state comprises: the residual electric quantity of the energy storage device being greater than second predetermined electric quantity.

7. The power management method according to claim 1, wherein the energy system further comprises a second power generation device configured to supply power to the power distribution device, and the method further comprises:
controlling the second power generation device to generate power or controlling the power distribution device to be connected to a public power grid when the first generated power is less than the consumed power and the energy storage device is in an unavailable-for-power-supply state,
wherein a power generation cost of the second power generation device is greater than a power generation cost of the first power generation device, and said the energy storage device being in the unavailable-for-power-supply state comprises: the residual electric quantity of the energy storage device being less than third predetermined electric quantity.

8. The power management method according to claim 7, wherein said controlling the second power generation device to generate power or controlling the power distribution device to be connected to the public power grid comprises:
controlling the power distribution device to be connected to the public power grid when the power generation cost of the second power generation device is greater than a current electricity consumption price of the public power grid and the energy system is in an on-grid state; and
controlling the second power generation device to generate power when the power generation cost of the second power generation device is less than the current electricity consumption price of the public power grid or the energy system is in an off-grid state.

9. The power management method according to claim 1, wherein:
the energy system further comprises a second power generation device having a power generation cost greater than a power generation cost of the first power generation device;
the power distribution device comprises a power supply circuit and a switch, the power supply circuit being connected to the switch, the switch being connected to the one or more loads, and the switch being configured to control on/off of the one or more loads; and
each of the first power generation device and the second power generation device is configured to supply power to the power supply circuit.

10. The power management method according to claim 9, wherein:
the one or more loads comprise a first load and a second load;
the switch is configured to keep the first load in a power-on state in each electricity consumption period, keep the second load in a power-on state in an electricity consumption period in which an electricity consumption price is less than a predetermined power price threshold, and keep the second load in a power-off state in an electricity consumption period in which the electricity consumption price is greater than the predetermined power price threshold; and
the first load has a higher real-time requirement than the second load.

11. The power management method according to claim 1, wherein:
the power distribution device further comprises a first switch and one or more second switches, the first switch being connected to the first power generation device, and the one or more second switches being connected to the one or more loads, respectively; and
said obtaining the first generated power of the first power generation device and the consumed power of the one or more loads comprises:
obtaining the first generated power of the first power generation device from the first switch; and
obtaining the consumed power of the one or more loads from the one or more second switches, respectively.

12. The power management method according to claim 1, wherein the energy system further comprises an energy management unit, the energy management unit comprising:
a first energy management unit having an independent structure and being electrically connected to a power supply circuit; and/or
a second energy management unit integrated in the first power generation device.

13. The power management method of claim 12, wherein each of the first energy management unit and the second energy management unit is configured to analyze received data and output a control strategy, the method further comprising:
determining, by the second energy management unit, that the first energy management unit is abnormal in response to the second energy management unit sending a detection signal to the first energy management unit but receiving no response signal returned by the first energy management unit; and
taking, by the second energy management unit, over the first energy management unit in response to the first energy management unit being abnormal.

14. An energy management device, comprising:
a processor; and
a memory storing a computer program, the computer program, when executed by the processor, implements:
obtaining first generated power of a first power generation device and consumed power of one or more loads;
controlling, when the first generated power is greater than the consumed power, an energy storage device to store power;
determining, based on a predetermined on-grid electricity price curve, an electricity selling period, wherein the on-grid electricity price curve comprises a plurality of electricity price periods, the electricity selling period is an electricity price period having an electricity price ranking that satisfies a predetermined ranking among the plurality of electricity price periods, and the electricity price ranking is based on an electricity selling price; and
outputting electric quantity of the energy storage device to a power grid during the electricity selling period, such that residual electric quantity of the energy storage device after said outputting to the power grid is greater than first predetermined electric quantity.

15. The energy management device according to claim 14, wherein said determining, based on the predetermined on-grid electricity price curve, the electricity selling period comprises:
determining, based on first generated power of each electricity consumption period, consumed power of each electricity consumption period, and the residual electric quantity of the energy storage device, an estimated time length required for the energy storage device to be fully charged; and
determining, based on the on-grid electricity price curve within the estimated time length, the electricity selling period.

16. The energy management device according to claim 14, wherein the computer program, when executed by the processor, further implements:
determining, based on a predetermined electricity consumption price curve, a target electricity consumption price; and
determining a target electricity selling period in which an electricity selling price is greater than the target electricity consumption price in the electricity selling period;
wherein said outputting the electric quantity of the energy storage device to the power grid during the electricity selling period, such that the residual electric quantity of the energy storage device after said outputting to the power grid is greater than the first predetermined electric quantity comprises:
outputting the electric quantity of the energy storage device to the power grid during the target electricity selling period, such that the residual electric quantity of the energy storage device after said outputting to the power grid is greater than the first predetermined electric quantity.

17. The energy management device according to claim 16, wherein:
the on-grid electricity price curve is predicted based on a historical on-grid electricity price; and
the electricity consumption price curve is predicted based on a historical electricity consumption price.

18. The energy management device according to claim 15, wherein the computer program, when executed by the processor, further implements:
obtaining weather information, and predicting, based on the weather information and a generated power curve of the first power generation device, second generated power of the first power generation device in each electricity consumption period; and
setting the first predetermined electric quantity based on the second generated power and the consumed power in each electricity consumption period within a predetermined time length.

19. An energy system, comprising a first power generation device, a power distribution device, an energy storage device, and the energy management device according to claim 14, wherein the energy management device is connected to the first power generation device, the power distribution device, and the energy storage device, and the power distribution device is connected to the first power generation device, the energy storage device, and the one or more loads.

20. A non-volatile computer-readable storage medium having a computer program, wherein the computer program, when executed by a processor, causes the processor to implement the power management method according to claim 1.
